(19) United States
(12) Patent Application Publication
(10) Pub. No.: US 2002/0148849 A1
(43) Pub. Date: Oct. 17, 2002

(54) Gravity feed product dispenser

(76) Inventors: Paul Edmond Robert, Lyndhurst, NJ (US); Barbara Vollmer Donegan, Lyndhurst, NJ (US)

Correspondence Address: BRUCE LONDA, NORRIS, MCLAUGHLIN & MARCUS, P.A., 220 EAST 42ND STREET, 30TH FLOOR, NEW YORK, NY, 10017, US

(21) Appl. No.: 09/833,829

(22) Filed: Apr. 12, 2001

(51) Int. Cl. B65H 1/00; B65G 59/00; B65H 3/00

(52) U.S. Cl. 221/131; 221/191

(57) ABSTRACT

A system for displaying and dispensing articles has at least one elongate chute residing removably and generally vertically within the housing; each chute has a port at a lower edge, adjacent the bottom end, for dispensing product. A preferred embodiment has a partition dividing the chute into front and back regions. Product is accessible from the back region, through the main port, upon opening a second port in the partition, outlined with a perforation.

### BACKGROUND OF THE INVENTION

The invention relates to an improved product dispenser, and more specifically, to a dispenser housing a plurality of removable chutes that can be filled with multiple columns of product, wherein each chute is capable of being easily reloaded or replaced.

A dispenser of this type is desirable for a manufacturer of product, because it allows the product to be pre-loaded into a dispensing display, which dispensing display is fashioned for easy and convenient shipment to the retailer. The retailer may then easily and quickly unpack and set up the display for almost immediate availability of product to the consumer. Furthermore, the structure of the dispenser is such that it provides broad space for graphics, which is beneficial to the manufacturer from a promotional standpoint. By having multiple, removable chutes, the display is flexible in allowing for dispensing of differing products, of different sizes. In addition, the retailer may easily restock a particular product by simply removing an entire empty chute, and inserting a fully stocked replacement chute. However, dispensers of the prior art all suffer from particular drawbacks, as is discussed below.

The dispenser such as that taught in U.S. Pat. No. 4,767,022 requires a magazine and sleeve arrangement, in which the magazine cannot be filled unless the sleeve is removed. Thus, the entire process is a four-step process: remove the magazine from the housing, remove the sleeve, fill the magazine, replace the sleeve, put the magazine into housing. Moreover, only one column of product can be replenished at one time. In addition, the device has a protruding shelf making the packaging of the device more cumbersome.

U.S. Pat. Nos. 1,974,926 and 1,966,676 relate to a dispensing device and its cartridge. The cartridge is replaceable and refillable. If the cartridge is to be refilled, however, a top flap must be opened in order to access the cartridge. Once again, only one column of product can be refilled at any one time. Only by opening this flap can the product be replenished in this device. Moreover, the dispensing device is not easily capable of being compacted for convenient packaging, due to its L-shaped design.

The device of U.S. Pat. No. 1,725,372 discloses a carton that dispenses product. The carton requires an overall enclosed design with an opening for dispensing product. In order to replace the product either the entire carton is discarded or the carton's top flap is opened to allow for replenishment. Moreover, the carton is not part of an entire display, but rather it stands alone, thereby making it less visible to consumers.

The instant invention solves the deficiencies stated in the aforementioned devices, while providing improvements as stated herein.

### SUMMARY

Accordingly, the present invention provides for a product dispenser comprising a housing having an open top end, a lower end in the form of a horizontal tray member, and a front face having an opening at a lower edge thereof, adjacent the lower end as a primary dispensing region. The invention has at least one elongate chute residing removably and generally vertically within the housing, wherein each chute comprises four vertical walls, including a front wall, a rear wall, and two side walls, and a closed bottom support member. The front vertical wall having an opening acting as a primary port for dispensing products, at a lower edge thereof adjacent to the bottom support member. The bottom support member extends from the rear wall toward the front wall, but preferably does not extend beyond the region of the front wall. The opening acts as a product dispensing port, while the bottom support member acts as a support for articles contained in the chute. The chute further comprises, in a further embodiment, a vertical partition extending along the length of the chute and between the side walls. The partition has an opening at a lower edge, which conforms generally in size and location to the opening in the front vertical wall. The partition may further comprise a removable region defined preferably by a perforation for revealing, upon removal of the region to reveal the opening in the partition.

### DESCRIPTION OF THE DRAWINGS

FIG. 1 is a perspective view of a preferred embodiment of the assembled invention.

FIG. 2 is a perspective view of a housing standing alone.

FIG. 3 is a perspective view of a chute removed from a housing.

FIG. 4 is a plan view of a partition removed from a chute.

FIG. 5 is a perspective view of a base used to display the housing on the floor.

FIG. 6 is a plan view of another embodiment of a chute showing a plurality of ports.

FIG. 7 is a cross section along line 6-6 of a chute showing a plurality of ports and corresponding shelf members.

FIG. 8 is another embodiment showing a side view of a chute with a recess in a side wall.

FIG. 9 is plan view of another embodiment showing the housing having a plurality of openings in substantial alignment with the openings in an elongate chute residing inside the housing.

### DETAILED DESCRIPTION OF THE INVENTION

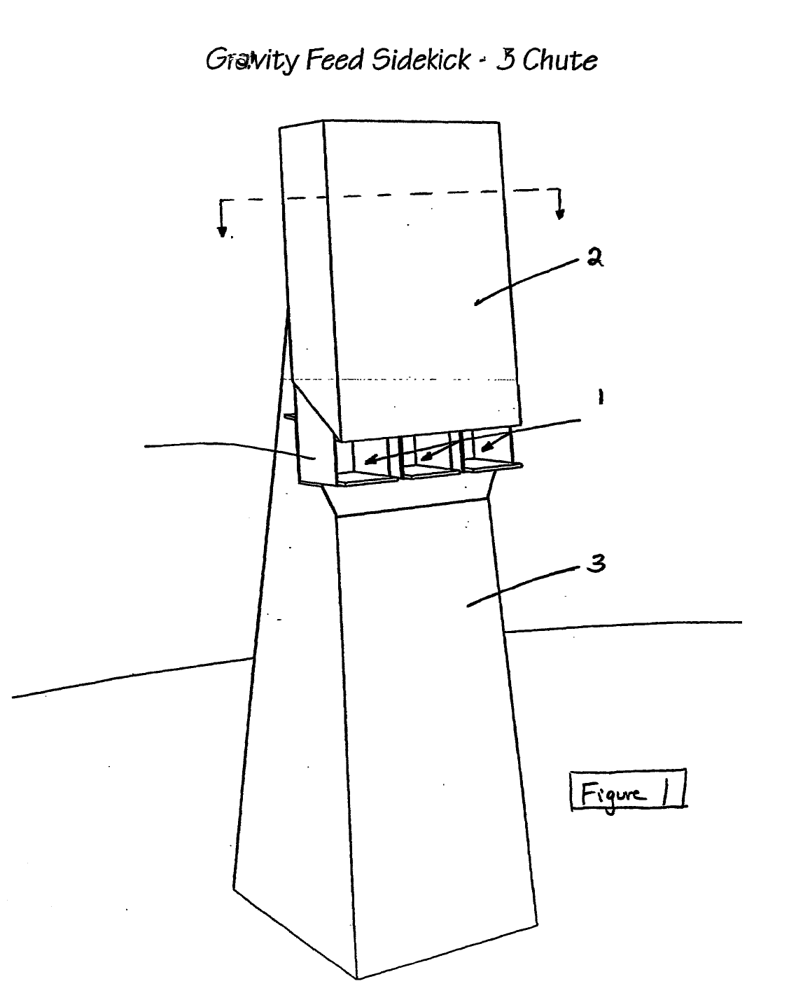

A product dispenser is shown in FIG. 1 comprising a base (3), a removable chute (1), and a housing (2). A plurality of removable chutes is shown vertically aligned and side-by-side inside the housing (2). At the rear of the housing (2) are two hooks (not shown) which are capable of operating as an attaching means for the housing (2) to the base (3). The housing (2) is attached to the base (3) at an angle greater than 90°. The display system is preferably made of a material such as cardboard, so as to make it compact, foldable and lightweight.

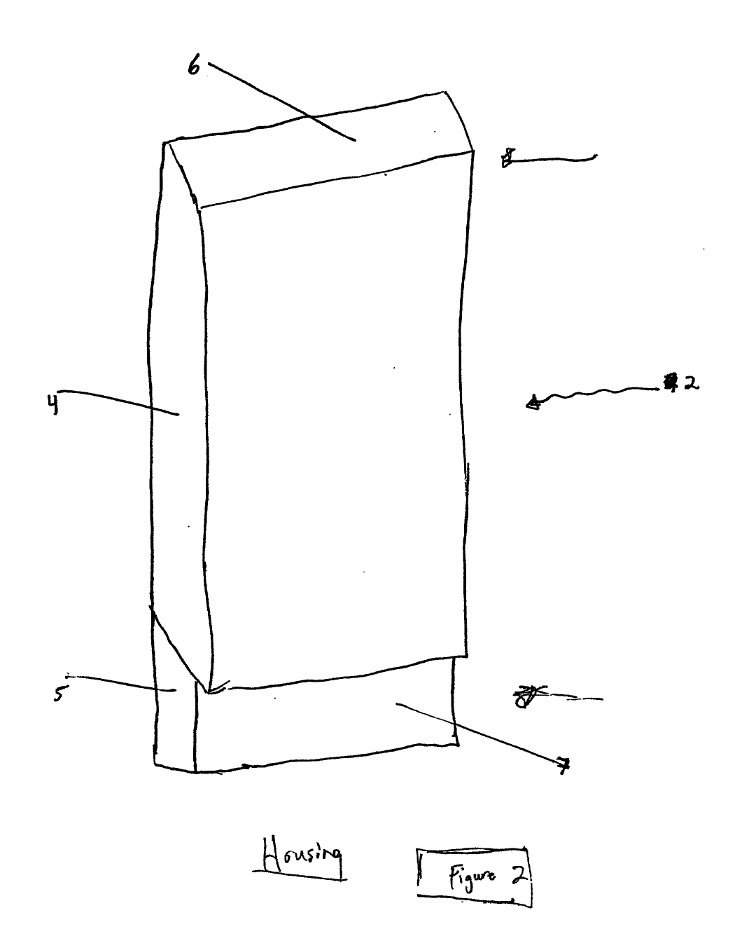

As shown in FIG. 2, the housing (2) is generally rectangular in shape, and it comprises a coverpiece (4), a tray (5), an upper opening (6) and a primary opening (7) at a lower edge thereof. The housing consists of the upper opening (6) and the primary opening (7), formed by the coverpiece (4) and the tray (5). The openings (6,7) are situated at opposing ends, and situated perpendicular to each other. The upper opening (6) is capable of receiving a removable chute (1), while the primary opening (7) is an entrance to a primary port (11) of the removable chute (1). In its preferred embodiment, the housing is capable of receiving a plurality of removable chutes in side-by-side orientation. The horizontal width of the housing is designed to meet generally accepted retail standards. The coverpiece (4) is fixedly attached to the tray (5), and is preferably formed, so as to substantially cover the tray (5) with the exception of the upper opening (6) and the primary opening (7) of the housing (2). In a further embodiment, FIG. 9 shows the coverpiece (4) having at least one secondary opening (26) located above the primary opening, that is substantially aligned with at least one secondary opening (27) on the chute (1), so as to be able to dispense different products from the same chute. The at least one secondary opening preferably extends around the front of the coverpiece, terminating on a side wall (31) of the coverpiece, in order to allow for easier access and removal of the products contained therein. It is contemplated that further second openings may be provided along the horizontal width of the coverpiece to correspond with further secondary ports located in additional chutes. Further, a single chute may have two or more secondary ports.

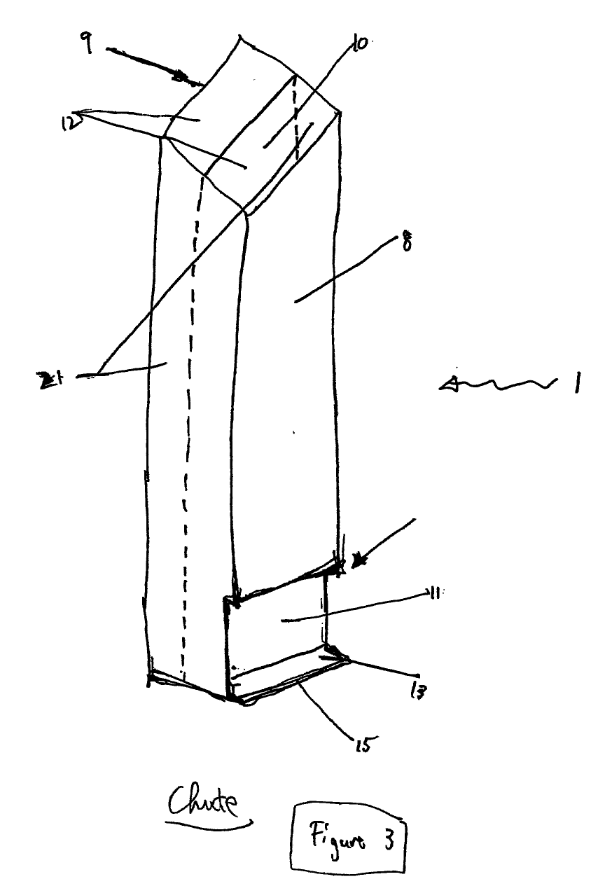

A removable chute (1) is generally rectangular in shape as shown in FIG. 3. It is defined by the size of the housing (2), wherein the front (8) and rear (9) walls preferably touch the housing (2) when the invention is assembled, to limit movement of the chute (1) within the housing (2). The plurality of chutes (1) situated inside the housing (2) are sized according to the size of a chute (1) relative to the size of the housing (2). It is contemplated that the number of removable chutes may be as few as one, based upon the requirements of the manufacturer. The chutes are preferably situated side-by-side inside the housing (2), occupying the entire interior of the housing (2). The chutes are sized in width according to the particular product to be accommodated. Dividers or fillers may be added inside the housing situated next to the chutes, in order to fill the remaining space that may be unoccupied by the chutes in certain configurations.

The removable chute (1) comprises a front wall (8), a rear wall (9), side walls (21), a primary port (11), and a primary shelf member (13). The front (8) and rear (9) walls are formed perpendicular to the side walls (21), extending upwardly. The primary port (11) is formed by the primary shelf member (13) and the front wall (8) extending substantially downward, wherein the length of the front wall (8) is sized according to the length of the primary port (11). The primary shelf member (13) is situated on the tray (5), and its lip (15) extends radially outward. The primary shelf member is shaped, so that the lip (15) is preferably flush with, or slightly rearward of the front wall (8). The substantial flush arrangement allows for ease of insertion of the chute into the housing and ease of transportation in a separate package, due to the absence of protruding elements, while also adding to stability of the chute within the housing. Thus, the entire invention can be packed easily and efficiently while minimizing worries of damage to any component of the invention.

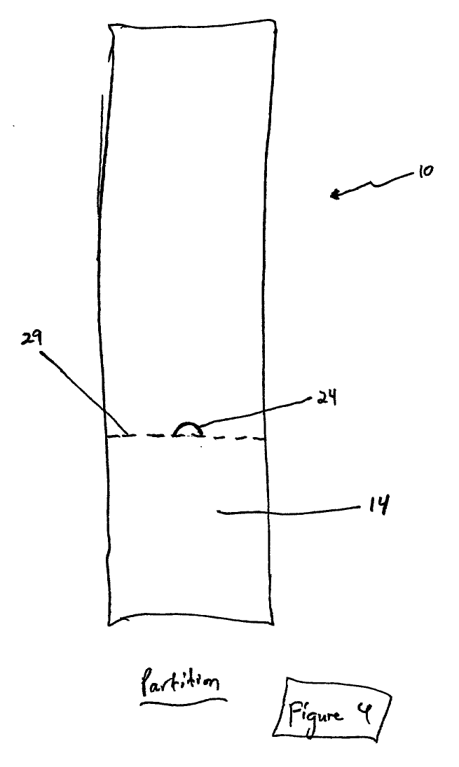

In a preferred embodiment, the removable chute (1) has a partition (10), which conforms in shape to the front (8) and rear (9) walls. The partition (10) extends parallel to the front (8) and rear (9) walls to form regions in the chute (1). The partition (10) further has, in a preferred embodiment, an optionally removable perforated section (14), with an optional finger pull (24) for access to compartments and products situated behind the partition as shown in FIG. 4. The finger pull (24) may be situated centrally atop an upper boundary (29) of the perforated section (14). The finger pull (24) allows a user to remove the perforated section (14) without damaging products contained in the compartment. When the front region is empty, the product contained in the rear region can be accessed once the partition is opened as above, thus allowing access through the primary opening. Another contemplated embodiment includes removable chutes that do not have the perforated section in the partition, thus allowing free access to the products situated behind the partition.

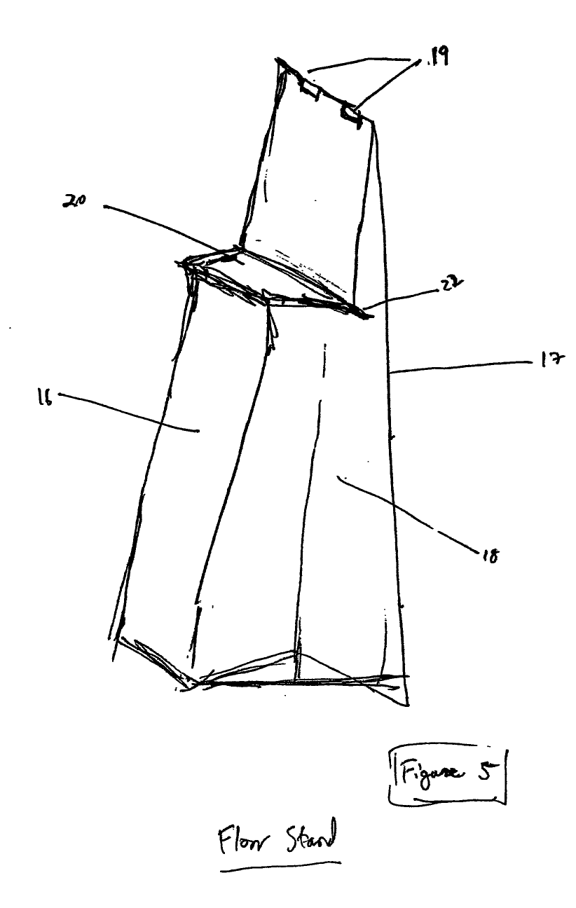

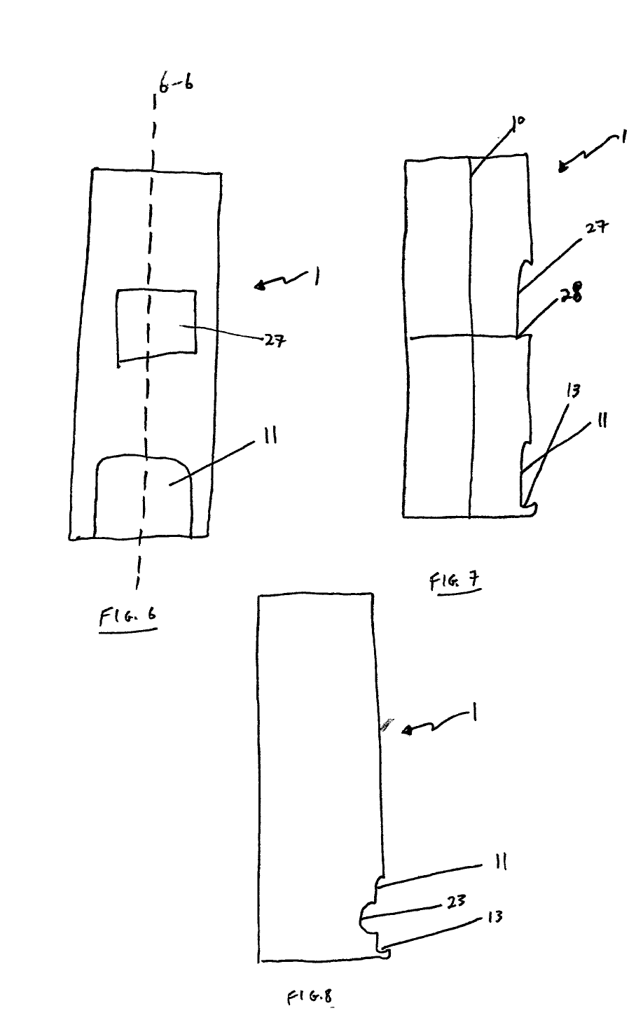

Another contemplated embodiment comprises the chute (1) having at least one secondary front opening (27) and a corresponding secondary shelf member (28) located adjacent the bottom of the secondary opening as shown in FIGS. 6 and 7. The corresponding openings (26) are provided in the front wall (8). Thus, different products can effectively be dispensed within a single chute (1). Another contemplated embodiment comprises the removable chute having a plurality of partitions, thereby forming a plurality of compartments, leaving multiple columns of product that can be loaded into a chute. Having multiple columns of product minimizes the number of times that a retailer has to replenish or replace the chute.

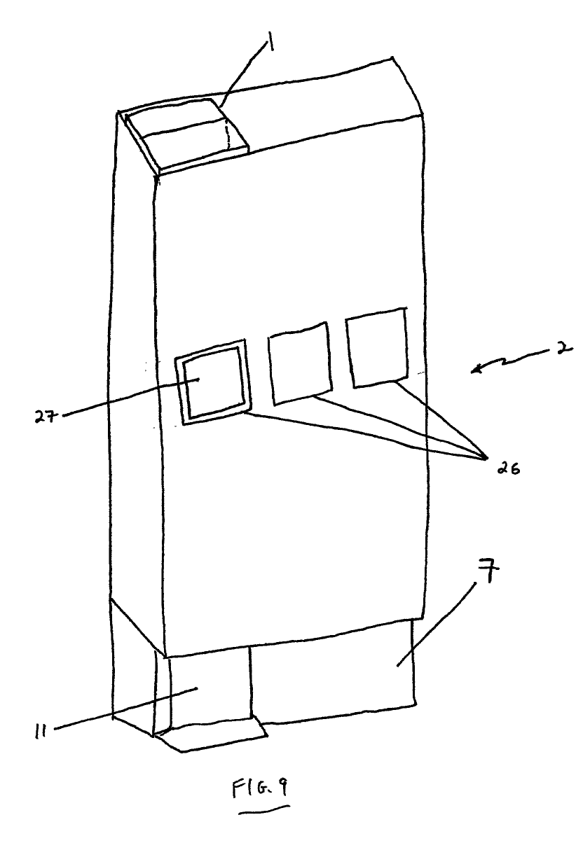

FIG. 8 shows another embodiment of the chute (1), wherein the chute (1) includes a recess (23) situated in each of the side walls directly opposite to each other. The recess (23) is further situated in the region of the side walls that define the port (11), thereby allowing the product to be withdrawn from the dispenser at a different place other than the shelf member. A further embodiment consists of removable chutes that can operate independently of the invention. Since the chutes are removable, they are capable of standing on a shelf. The aforementioned embodiments are not limiting, but are meant to only illustrate examples.

In FIG. 5, a preferred version of a base for supporting the dispenser housing is shown having a preferably square base, generally comprising a front panel (16), a back panel (17), and side panels (18). The back panel is defined by a plurality of notches (19), which are coupled to the hooks on the housing. The front panel has supporting shelf (20) radially extending outward, which may be formed by folding the front panel along predetermined lines, and inserting provided tabs into the slits (22) of the side panels. When the housing is attached to the base as shown in FIG. 1, the supporting shelf is angled back so as to hold the housing thereon against forward rotation.

What is claimed is:

1. A system for displaying and dispensing products, comprising
a housing having an openable top end, a lower end in the form of a horizontal tray member, and a front face having a first opening, at a lower edge thereof, adjacent said lower end,
at least one elongate chute residing removably and generally vertically within said housing, said chute comprising four vertical walls, including a front wall, a rear wall, and two side walls, a closed bottom support member, a front vertical wall having a second opening at a lower edge thereof, adjacent a region of said bottom support member, and substantially aligned with the first opening when the chute is in the housing.

2. The system of claim 1, wherein the at least one chute comprises a vertical partition extending along the length of the chute and between the side walls, said partition having a third opening at a lower edge thereof, conforming in size and location to the second opening.

3. The system of claim 1, wherein the at least one chute comprises a vertical partition extending along the length of the chute and between the side walls, said partition having a removable region, which defines upon removal of the region, a third opening at a lower edge thereof, conforming in size and location to said second opening.

4. The system of claim 1, wherein said bottom end extends forward from said rear wall toward said front wall, but does not extend substantially beyond the region of said front wall.

5. The system of claim 1, wherein the at least one chute comprises a pair of recessed elements, said recessed elements situated along a lower portion of the side walls, wherein said lower portion is defined by said second opening.

6. The system of claim 1, wherein said front face of said housing comprises a fourth opening, above the first opening, and wherein the at least one elongate chute comprises a fifth opening, which substantially corresponds in size and location to the fourth opening when the chute resides in the housing.

7. The system of claim 6, wherein the at least one elongate chute comprises a second bottom support member adjacent a region of a lower edge of the fifth opening.
